(19) United States
(12) Patent Application Publication
(10) Pub. No.: US 2006/0269820 A1
(43) Pub. Date: Nov. 30, 2006

(54) Testing fixture for membrane electrode assembly

(76) Inventors: Ko-Chen Shen, Taipei (TW); Tsang-Ming Chang, Taipei (TW)

Correspondence Address: G. LINK Co., LTD, 3550 Bell Road, MINOOKA, IL, 60447, US

(21) Appl. No.: 11/137,663

(22) Filed: May 26, 2005

(51) Int. Cl. H01M 8/04; G01N 27/26

(52) U.S. Cl. 429/38; 204/409

(57) ABSTRACT

This invention relates to a testing fixture for membrane electrode assembly, for testing performance of the membrane electrode assembly, the testing fixture including a first mold unit and a second mold unit. The first and second mold units are capable of clamping towards and separating from each other, and during testing, the membrane electrode assembly is interposed between the first and second mold units clamped to each other. The first mold unit supplies anode fuel to an anode of the membrane electrode assembly and includes a first retaining plate, an anode fuel flow field plate and an anode current collection plate. The second mold unit supplies cathode fuel to a cathode of the membrane electrode assembly and includes a second retaining plate, a cathode fuel flow field plate and a cathode current collection plate.

### FIELD OF THE INVENTION

This invention relates to a testing fixture for membrane electrode assembly, particularly to one capable for applying conditions to the membrane electrode assembly for performing electro-chemical reactions, and then testing the membrane electrode assembly under the electro-chemical reactions.

### BACKGROUND OF THE INVENTION

The related prior art disclosed a method and structure for testing performance of fuel cell after assembly, relating to a structure for testing performance of a fuel cell after assembly, including a membrane electrode assembly and bipolar plate provided with the membrane electrode assembly therein. The bipolar plate is provided at each of the exteriors thereof with conductive elements. The conductive elements are tightly pressed against exteriors thereof by means of a press plate. The membrane electrode assembly is a conductive material and the conductive material is formed thereon with plural apertures, such that the conductive material having breathability greater than that of the air dissipation layer. The prior art is mainly implemented in testing breathability of the membrane electrode assembly, but is incapable of testing whether the membrane electrode assembly is able to perform normal electro-chemical reactions for generating current.

This invention intends to resolve the shortcoming of the conventional membrane electrode assembly where does not permit electrical and dynamic testing, thereby providing a testing fixture capable of testing the membrane electrode assembly under electro-chemical reactions through easy operations.

### SUMMARY OF INVENTION

It is a first object of this invention to provide a testing fixture capable of testing the membrane electrode assembly under electro-chemical reactions through easy operations.

It is a further object of this invention to provide a testing fixture capable for applying conditions to the membrane electrode assembly for performing electro-chemical reactions, and then testing the membrane electrode assembly under the electro-chemical reactions.

To achieve the above objects, this invention provides a testing fixture for membrane electrode assembly, for testing performance of membrane electrode assembly. The testing fixture includes a first mold unit and a second mold unit, wherein the first mold unit and second mold unit are capable of clamping towards and separating from each other, and during testing, the membrane electrode assembly is interposed between the first and second mold units clamped to each other. The first mold unit supplies anode fuel to an anode of the membrane electrode assembly, and includes a first retaining plate, an anode fuel flow field plate and an anode current collection plate. The second mold unit supplies cathode fuel to a cathode of the membrane electrode assembly and includes a second retaining plate, a cathode fuel flow field plate, and a cathode current collection plate.

### BRIEF DESCRIPTION OF THE DRAWINGS

These and other modifications and advantages will become even more apparent from the following detained description of a preferred embodiment of the invention and from the drawings in which:

FIG. 1 illustrates a perspective view of the testing fixture for membrane electrode assembly according to this invention;

FIG. 2 illustrates a schematic view using the testing fixture according to this invention to test a membrane electrode assembly;

FIG. 3 illustrates an exploded view of a first embodiment of the testing fixture according to this invention;

FIG. 4 illustrates an exploded view of a second embodiment of the testing fixture according to this invention;

FIG. 5 illustrates a structural view of a membrane electrode assembly retaining plate according to this invention; and

FIG. 6 illustrates a schematic view using the testing fixture according to this invention and a membrane electrode assembly retaining plate to test a membrane electrode assembly.

### DETAILED DESCRIPTION OF THE INVENTION

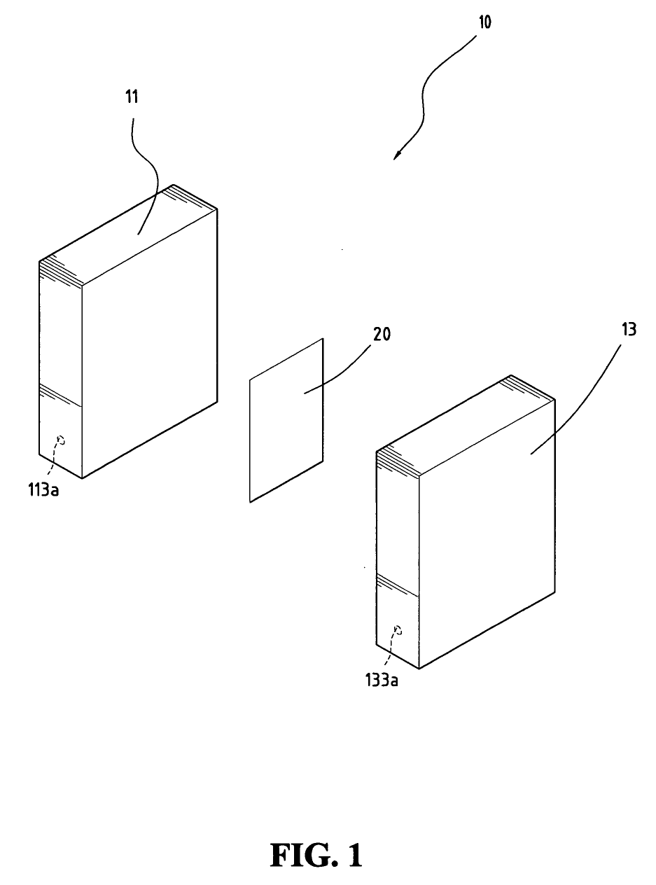

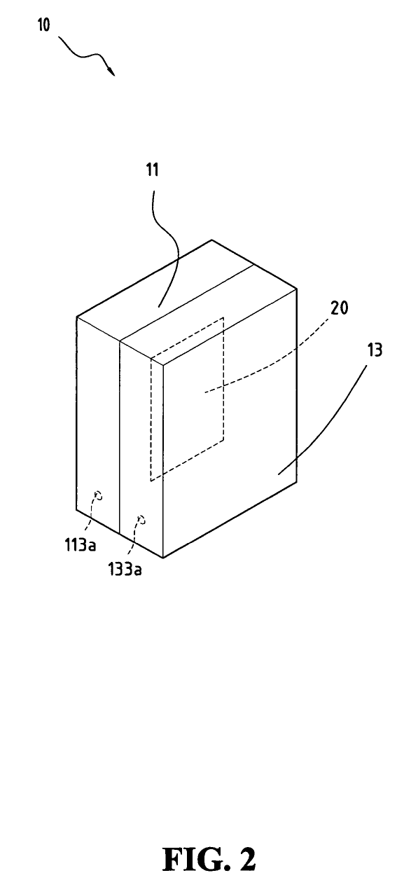

FIG. 1 illustrates a perspective view of the testing fixture for membrane electrode assembly according to this invention, and FIG. 2 illustrates a schematic view using the testing fixture according to this invention to test a membrane electrode assembly. According to this invention, the testing fixture 10 is mainly implemented in testing a membrane electrode assembly 20 used in a fuel cell. During testing, the membrane electrode assembly 20 is interposed between a first mold unit 11 and a second mold unit 13. Further, the first mold unit 11 is able to supply anode fuel to the membrane electrode assembly 20, and the second mold unit 13 is able to supply cathode fuel to the membrane electrode assembly 20, so as to result in electro-chemical reactions of the membrane electrode assembly 20 for generating current. Since the first mold unit 11 and second mold unit 13 of this invention are capable of clamping towards or separating from each other, when the testing is completed, the first mold unit 11 and second mold unit 13 are separated to remove the membrane electrode assembly 20 that has been tested. According to testing fixture 10 of this invention allows easily testing of each membrane electrode assembly 20 to be tested.

In response to the conditions and characteristics of the electro-chemical reaction occurred within the membrane electrode assembly 20, such as the membrane electrode assembly of a direct methanol fuel cell, the cathode fuel required by its cathode may also be directed supplied from ambient air. Accordingly, the testing fixture 10 of this invention may alternatively adopt a single-side first mold unit 11 and cathode current collection plate 135 for clamping the membrane electrode assembly 20, to allow easy testing of each membrane electrode assembly 20 to be tested.

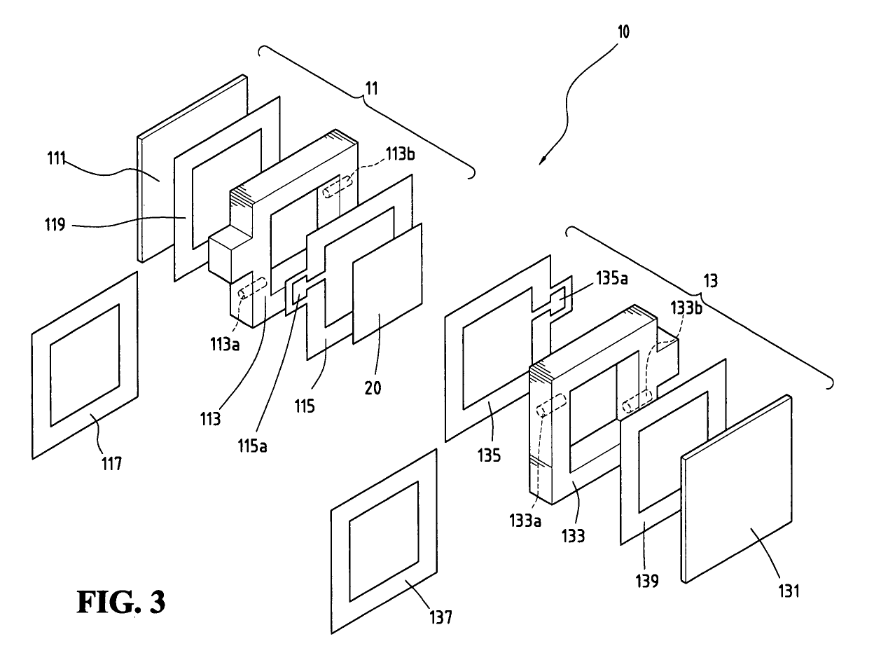

FIG. 3 illustrates an exploded view of a first embodiment of the testing fixture according to this invention. In FIG. 3, the testing fixture 10 mainly includes a first mold unit 11 and a second mold unit 13. The first mold unit 11 mainly includes a first retaining plate 111, an anode fuel flow field plate 113 and an anode current collection plate 115; and the second mold unit 13 mainly includes a second retaining plate 131, a cathode fuel flow field plate 133 and a cathode current collection plate 135. The anode fuel flow field plate 113 and cathode fuel flow field plate 133 in the first embodiment are each configured to a hollow frame, such that the anode fuel of the anode fuel flow field plate 113 and the cathode fuel in the cathode fuel flow field plate 133 may flow towards the anode and cathode of the membrane electrode assembly 20, respectively. Furthermore, the anode fuel flow field plate 113 is provided with an anode fuel injection port 113a, for injecting externally-originated anode fuel, such as anode fuel in the form of methanol solution. The cathode fuel flow field plate 133 is provided with a cathode fuel injection port 133a, for injecting externally-originated cathode fuel, such as cathode fuel from the air. Furthermore, the anode fuel flow field plate 113 is provided with a draining port 113b, for draining anode reactant to the ambient. The cathode fuel flow field plate 133 is provided with a draining port 133b, for draining cathode reactant to the ambient.

In the first embodiment, in order to further prevent leakage and dissipation of the anode fuel, cathode fuel and reactant (such as moisture) in the testing fixture 10, the first mold unit 11 is further provided with a first anti-leakage pad 117 and a third anti-leakage pad 119, and the second mold unit 13 is further provided with a second anti-leakage pad 137 and a fourth anti-leakage pad 139. The first anti-leakage pad 117 is interposed between the anode fuel flow field plate 113 and the anode current collection plate 115; the third anti-leakage pad 119 is interposed between the first retaining plate 111 and the anode fuel flow field plate 113; the second anti-leakage pad 137 is interposed between the cathode fuel flow field plate 133 and the cathode current collection plate 135; and the fourth anti-leakage pad 139 is interposed between the second retaining plate 131 and the cathode fuel flow field plate 133.

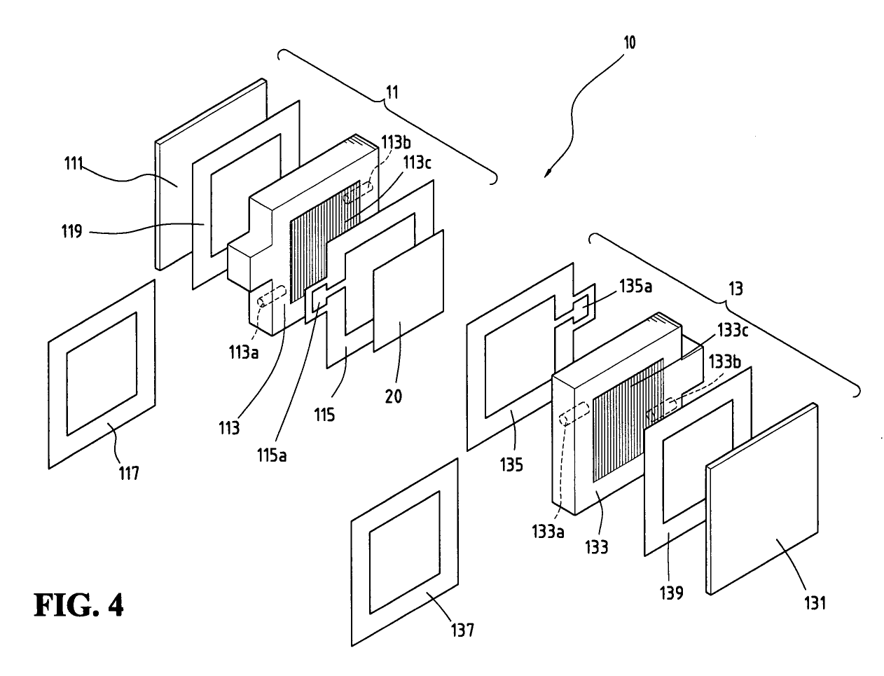

FIG. 4 illustrates an exploded view of a second embodiment of the testing fixture according to this invention. In FIG. 4, the testing fixture 10 also includes a first mold unit 11 and a second mold unit 13. The first mold unit 11 mainly includes a first retaining plate 111, an anode fuel flow field plate 113 and an anode current collection plate 115, and the second mold unit 13 mainly includes a second retaining plate 131, a cathode fuel flow field plate 133 and a cathode current collection plate 135. The flow field plate 113 and cathode fuel flow field plate 133 in the second embodiment each include plural flow channels 113c, 133c, and the anode fuel is able to flow through the flow channels 113c, and to finally flow towards the anode of the membrane electrode assembly 20. Similarly, the cathode fuel is able to flow through the flow channels 133c, and to finally flow towards the cathode of the membrane electrode assembly 20. Furthermore, the anode fuel flow field plate 113 is provided with an anode fuel injection port 113a, for injecting externally-originated anode fuel, such as anode fuel in the form of methanol solution. The cathode fuel flow field plate 133 is provided with a cathode fuel injection port 133a, for injecting externally-originated cathode fuel, such as cathode fuel in the form of air. Both the anode fuel and cathode fuel injected therein from an externally-originated source flow towards the anode and cathode of the membrane electrode assembly 20 through the flow channels 113c, 133c, respectively. Furthermore, the anode fuel flow field plate 113 is provided with a draining port 113b, for draining the anode reactant to the ambient, and the cathode fuel flow field plate 133 is provided with a draining port 133b, for draining the cathode reactant to the ambient.

In the second embodiment, in order to further prevent leakage and dissipation of the anode fuel, cathode fuel and reactant (such as moisture) in the testing fixture 10, the first mold unit 11 is further provided with a first anti-leakage pad 117, and the second mold unit 13 is further provided with a second anti-leakage pad 137. The first anti-leakage pad 117 is interposed between the anode fuel flow field plate 113 and the anode current collection plate 115, and the second anti-leakage pad 137 is interposed between the cathode fuel flow field plate 133 and the cathode current collection plate 135. Furthermore, to further enhance the anti-leakage effect, a third anti-leakage pad 119 and a fourth anti-leakage pad 139 may be optionally provided. The optional third anti-leakage pad 119 is interposed between the first retaining plate 111 and the anode fuel flow field plate 113. Similarly, the optional fourth anti-leakage pad 139 is interposed between the second retaining plate 131 and the cathode fuel flow field plate 133.

In the first and second embodiments, the first anti-leakage pad 117, second anti-leakage pad 137, third anti-leakage pad 119 and fourth anti-leakage pad 139 are made of a rubber material or a material with a constant compression amount.

The first retaining plate 111, anode fuel flow field plate 113 and anode current collection plate 135 included in the above first mold unit 11, and the second retaining plate 131, cathode fuel flow field plate 133 and cathode current collection plate 135 included in the second mold unit 13, can all use PCB (Printed Circuit Board) as their base material, or it can be made of a material selected from a polymer material and a composite material and formed by PCB fabrication processes.

The above anode current collection plate 115 and cathode current collection plate 135 may further be provided with an anode testing terminal 115a and cathode testing terminal 135a, respectively, where the testing terminals 115a, 135a serve to connect to an external, electrical testing fixture, such as a potentiometer or a galvanometer, so as to perform electrical testing of the membrane electrode assembly 20 by means of the electrical testing fixture.

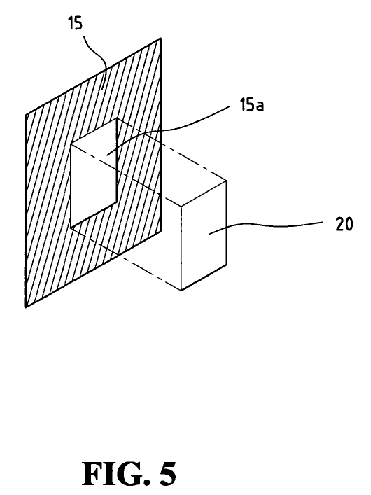

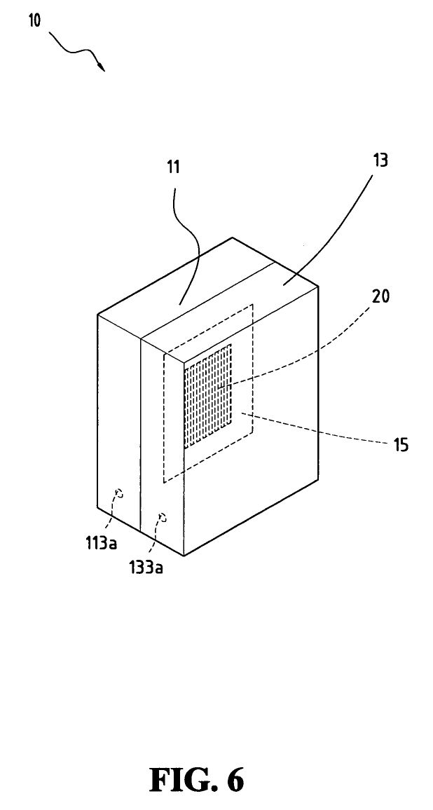

FIG. 5 illustrates a structural view of a membrane electrode assembly retaining plate according to this invention, and FIG. 6 illustrates a schematic view using the testing fixture according to this invention and a membrane electrode assembly retaining plate to test a membrane electrode assembly. The membrane electrode assembly retaining plate 15 is formed in an interior region thereof with a hollow region 15a, where the hollow region 15a is dimensioned to conform to the membrane electrode assembly 20. The membrane electrode assembly retaining plate 15 is preferred to have a thickness that is the same as or extremely close to the thickness of the membrane electrode assembly 20. During testing, the membrane electrode assembly 20 is first placed in the hollow region 15a, such that the membrane electrode assembly 20 may be positioned and retained within the membrane electrode assembly retaining plate 15. The membrane electrode assembly retaining plate 15 that has positioned and retained the membrane electrode assembly 20 is then interposed between the first mold unit 11 and second mold unit 13.

The means for clamping the first mold unit 11 and second mold unit 13 may be external forces applied to exteriors of the first retaining plate 111 and second retaining plate 131. Alternatively, a claming tool may be used to clamp the first mold unit 11 and second mold unit 13 together. For example, such claming tool may be a bolt penetrating the first mold unit 11 and second mold unit 13.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

What is claimed is:

1. A testing fixture for membrane electrode assembly, for testing performance of a membrane electrode assembly, comprising: a first mold unit and a second mold unit, wherein the first mold unit and the second mold unit are capable of clamping towards and separating from each other, and during testing, the membrane electrode assembly is interposed between the first and second mold units clamped to each other;
the first mold unit supplying anode fuel to an anode of the membrane electrode assembly, and including: a first retaining plate, an anode fuel flow field plate, and an anode current collection plate ; and
the second mold unit supplying cathode fuel to a cathode of the membrane electrode assembly, and including: a second retaining plate, a cathode fuel flow field plate, and a cathode current collection plate.

2. The testing fixture of claim 1, wherein the anode fuel flow field plate includes an anode fuel injection port and a draining port.

3. The testing fixture of claim 1, wherein the cathode fuel flow field plate includes a cathode fuel injection port and a draining port.

4. The testing fixture of claim 1, wherein the first mold unit is selected from a PCB, a polymer material and a composite material and formed by PCB fabrication processes.

5. The testing fixture of claim 1, wherein the second mold unit is selected from a PCB, a polymer material and, a composite material and formed by PCB fabrication processes.

6. The testing fixture of claim 1, wherein the first retaining plate further includes a first anti-leakage pad interposed between the anode fuel flow field plate and the anode current collection plate; and the second retaining plate further includes a second anti-leakage pad interposed between the cathode fuel flow field plate and the cathode current collection plate.

7. The testing fixture of claim 1, wherein the anode fuel flow field plate is configured to a hollow frame; and wherein the cathode fuel flow field plate is configured to a hollow frame.

8. The testing fixture of claim 7, wherein the first retaining plate further includes a third anti-leakage pad interposed between the first retaining plate and the anode fuel flow field plate; and wherein the second retaining plate further includes a fourth anti-leakage pad interposed between the second retaining plate and the cathode fuel flow field plate.

9. The testing fixture of claim 6, wherein the first anti-leakage pad, the second anti-leakage pad, the third anti-leakage pad and the fourth anti-leakage pad are each made of a material selected from a rubber material, a material with a constant compression amount.

10. The testing fixture of claim 8, wherein the first anti-leakage pad, the second anti-leakage pad, the third anti-leakage pad and the fourth anti-leakage pad are each made of a material selected from a rubber material, a material with a constant compression amount.

11. The testing fixture of claim 1, wherein the anode fuel flow field plate includes plural flow channels; and wherein the cathode fuel flow field plate includes plural flow channels.

12. The testing fixture of claim 1, wherein the membrane electrode assembly, is a membrane electrode assembly of a direct methanol fuel cell.

13. The testing fixture of claim 1, wherein the first mold unit and the second mold unit is clamped by an external force.

14. The testing fixture of claim 1, wherein the first mold unit and the second mold unit is clamped by a clamping tool.

15. The testing fixture of claim 14, wherein the claming tool is a bolt penetrating the first mold unit and the second mold unit.

16. The testing fixture of claim 1, wherein the anode current collection plate includes an anode testing terminal; and the cathode current collection plate includes a cathode testing terminal.

17. The testing fixture of claim 1, wherein the testing fixture further includes a membrane electrode assembly retaining plate for positioning and retaining the membrane electrode assembly, such that during testing, the membrane electrode assembly retaining plate of the membrane electrode assembly that has been positioned and retained is interposed between the first and second mold units clamped to each other.
